(19) United States
(12) Patent Application Publication
(10) Pub. No.: US 2006/0095855 A1
(43) Pub. Date: May 4, 2006

(54) HMI reconfiguration method and system

(76) Inventors: Clinton Duane Britt, Milwaukee, WI (US); Robert F. Lloyd, Muskego, WI (US); Krista Mann, Waukesha, WI (US); Joseph Francis Mann, Waukesha, WI (US); Steven Mark Cisler, Franklin, WI (US)

Correspondence Address: ROCKWELL AUTOMATION, INC./(FY), ATTENTION: SUSAN M. DONAHUE, 1201 SOUTH SECOND STREET, MILWAUKEE, WI, 53204, US

(21) Appl. No.: 10/980,588

(22) Filed: Nov. 3, 2004

(51) Int. Cl. G06F 9/00

(52) U.S. Cl. 715/760; 715/764; 715/961

(57) ABSTRACT

Embodiments of the present invention relate to a system and method of reconfiguring a human-machine interface. In accordance with embodiments of the present techniques, a plurality of control objects may be accessed from a human-machine interface via a configuration station. The control objects may include properties for accessing inputs via an industrial control and monitoring network, performing a function based on the inputs, and outputting a signal to a remote device via the industrial control and monitoring network. Additionally, a display page may be configured on the configuration station using Web page creation software, including links to the control objects, to create a display file in accordance with the present techniques. Further, the display file may be downloaded to the human-machine interface for display of the display page and execution of the links to the control objects.

### BACKGROUND

The present invention relates generally to the field of industrial computer terminals and equipment interfaces, such as those used in industrial and commercial settings. More particularly, embodiments of the present invention relate to techniques for accessing, configuring, and creating applications for utilization with such terminals and with related devices.

Industrial computer terminals generally implement electronic tools or applications adapted for use in monitoring and/or control of system functions relating to a process or piece of industrial equipment. For example, a terminal may comprise a human-machine interface (HMI). An HMI may include a device or application adapted to present information to an operator about the state of a process or system and/or to accept and implement instructions received from the operator. Further, an HMI may be adapted to interpret process information and guide interactive procedures between an operator and a system. For example, an HMI may provide historical data, real-time value data, and alarm data relating to system components and dynamic process values in a system. Such data may be useful in guiding an operator through procedural operations in response to status changes in a system. Indeed, the HMI may present information in the form of charts, graphs, lists and so forth to facilitate access to system parameters and to provide clear guidelines to an operator. Such data may provide information relating to the status and operation of motors, valves, temperature elements, pressure sensors, and material handling equipment (e.g., conveyors, stackers, pumps, etc.) to mention only a few.

HMIs are typically configured to operate with a particular system (e.g., a processing plant) or piece of equipment (e.g., a compressor) through the use of process integration software. For example, a terminal on which an HMI is installed may interface with a system or piece of equipment using a set of specially configured HMI graphic screens developed for use with a certain process integration software application. Such software applications typically function with a specific type of terminal and are configured to relate to a particular system or piece of equipment (e.g., configured to be graphically representative of components in a system). Further, in existing techniques, these applications are generally created either directly on the terminal or are downloaded from a computer after being assembled on the computer using specialized configuration software.

Some existing HMIs are configured directly on the terminals themselves. For example, graphical interfaces for these terminals are generally created using proprietary protocols that reside within the terminal or that partially form aspects of the terminal. Indeed, such terminals are essentially integral to the process of creating the interfaces that the terminals themselves will utilize. In other words, terminals such as these are typically not flexible enough to allow the creation of resident graphical interfaces without the terminal being present during configuration and development. However, some existing terminals are adapted to utilize offline programming packages to create screens without the terminal being present. For example, a user may create an application having terminal graphics (e.g., an operable button or dynamic gauge) and then proceed to download the application into the terminal. This type of downloading operation comprises the utilization of a conversion program, such as an off-line programmer (OLP).

Conversion programs are used in existing terminal configuration techniques to convert applications into information that a designated terminal is capable of reading and executing. Such conversions enable the use of external programming software (i.e., software that is separate from the terminal) for the development and configuration of the terminal (e.g., the creation of terminal graphics on website development software). It should be noted that while such conversion applications are generally effective, they may introduce various problems into the creation and operation of a terminal application. For example, a particular OLP may function improperly, thus introducing unreliability into the operation of an HMI and into a process with which the HMI interfaces. Additionally, using and creating conversion applications may be time consuming, inefficient, and costly. For example, new revisions in an integration software package may necessitate the programming of a new OLP to enable conversion of a new type of functionality.

Accordingly, what is needed is a more efficient, robust, and cost effective technique for creating and configuring terminals and related applications.

### BRIEF DESCRIPTION

Embodiments of the present invention relate to a system and method of reconfiguring a human-machine interface without necessitating the use of a conversion program or a specialized OLP. Exemplary features of the invention are described in this section. Additional and alternative features and embodiments will be discussed in further detail below.

In accordance with embodiments of the present techniques, functional modules or control objects, and a set of screen instructions on a human-machine interface may be accessed via a web-based reconfiguration tool. For example, in accordance with present techniques, a set of control objects may reside on the HMI, and such control objects may be adapted for uploading to a configuration station. The functional modules may be configured for various functions. Indeed, in accordance with present techniques, the functional modules may be adapted to generate configurable views to be displayed on a display, interpret inputs received via an input device, process parameter signals received from remote devices, and generate output signals for reporting to or controlling remote devices. The screen instructions in accordance with the present techniques may be configured for generating the configurable views and calling upon the functional modules based upon inputs received via the input device. Additionally, in accordance with present techniques either the functional modules or the screen instructions may be reconfigured via the web-based reconfiguration tool, which may reside in the configuration station. Upon reconfiguration of the functional modules or screen instructions the updated version may be stored again in the HMI by downloading them from the configuration station.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary control and monitoring system including a human-machine interface (HMI) adapted to interface with networked components and configuration equipment in accordance with embodiments of the present techniques;

FIG. 2 is a block diagram illustrating interaction among components of both an HMI and a configuration station in accordance with embodiments of the present techniques;

FIG. 3 is an exemplary representation of a configuration screen that is part of a configuration application package in accordance with embodiments of the present techniques; and

FIG. 4 is a block diagram illustrating a method for configuring and implementing an application using a standard web interface in accordance with embodiments of the present techniques.

### DETAILED DESCRIPTION

Embodiments of the present invention relate generally to the field of industrial computer terminals and equipment interfaces, such as those used in industrial and commercial settings. These computer terminals, equipment interfaces, and related devices may generally be referred to as human-machine interfaces (HMIs). More particularly, embodiments of the present invention relate to techniques for accessing, configuring, and creating applications for utilization with such HMIs.

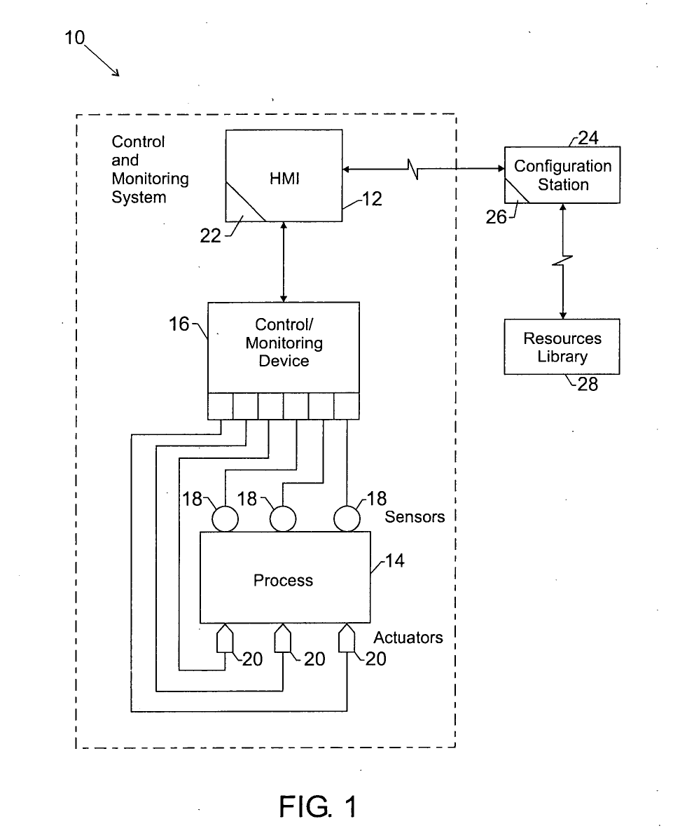

FIG. 1 is a diagrammatical representation of an exemplary control and monitoring system including an HMI adapted to interface with networked components and configuration equipment in accordance with embodiments of the present techniques. The control and monitoring system may generally be referred to by reference numeral 10. Specifically, the control and monitoring system 10 is illustrated as including an HMI 12 adapted to interface with components of a process 14 through a control/monitoring device 16. It should be noted that such an interface in accordance with embodiments of the present techniques may be facilitated by the use of certain network strategies. Indeed, an industry standard network may be employed, such as DeviceNet, to enable data transfer. Such networks permit the exchange of data in accordance with a predefined protocol, and may provide power for operation of networked elements.

The process 14 may take many forms and include devices for accomplishing many different and varied purposes. For example, the process may comprise a compressor station, an oil refinery, a batch operation for making food items, a mechanized assembly line, and so forth. Accordingly, the process 14 may comprise a variety of operational components, such as electric motors, valves, actuators, temperature elements, pressure sensors, or a myriad of manufacturing, processing, material handling and other applications. Further, the process 14 may comprise control and monitoring equipment for regulating process variables through automation and/or observation. For example, the illustrated process 14 comprises sensors 18 and actuators 20. The sensors 18 may comprise any number of devices adapted to provide information regarding process conditions. The actuators 20 may include any number of devices adapted to perform a mechanical action in response to an input signal.

As illustrated, these sensors 18 and actuators 20 are in communication with the control/monitoring device 16 (e.g., a programmable logic controller) and may be assigned a particular address in the control/monitoring device 16 that is accessible by the HMI 12. It should be noted that in some embodiments of the present techniques, the sensors 18 and actuators 20 are in direct communication with the HMI 12. These devices (sensors 18 and actuators 20) may be utilized in accordance with embodiments of the present techniques to operate process equipment. Indeed, they may be utilized within process loops that are monitored and controlled by the control/monitoring device 16 and/or the HMI 12. Such a process loop may be activated based on process inputs (e.g., input from a sensor 18) or direct operator input received through the HMI 12.

The HMI 12, in accordance with embodiments of the present techniques, may be thought of as including instructions for presenting one or more screen views, and functional modules or control objects executed upon interaction with the HMI by reference to the screen views. The screen views may be defined by any desired software or software package. In a present implementation, the screen views are defined by appropriate code written in a markup language (e.g., Hypertext Markup Language or HTML). Thus, as described in greater detail below, the configuration of graphical interface screens for the HMI may be performed without the use of conversion programs.

The functional modules or control objects are generally pre-defined computer code that execute a desired function. Each object may be considered generally to have various “properties”, with typical properties including inputs (e.g., register locations on a networked device from which information is drawn), functions (e.g., transformations performed or calculations made based on the inputs), and outputs (e.g., registers of networked devices to which information is to be written). In a simple case, an object may simply access a piece of data (e.g., a state of a component as determined by a sensor), and generate an output signal to write a value corresponding to the state to a different networked device. Much more complex functionality can, of course, be configured. In an industrial control and monitoring context, for example, such objects may emulate operation of a momentary contact push button, a push button with delayed output, a switch, and so forth.

Many such pre-programmed functional modules or control objects may be available for use by the HMI and may be resident on the terminal on which the HMI is installed. The screen instructions may then call upon the control objects for performing desired functions based upon operator inputs. For example, the operator may touch a location on a touch screen or depress keys on a keyboard as initiating inputs. Based upon the screen instructions and the control objects associated with the instructions (e.g., with specific locations triggering calls or execution of pre-configured control objects) the desired functions are then executed, enabling the operator to interact with the process.

In a typical HMI, one or more separate interface screens may be employed, with some HMIs defined via many such screens and a great number of control objects. Each control object may, in turn, be uniquely programmed to consider specific inputs, perform specific functions, and generate signals for specific outputs. Moreover, any suitable code may be employed to devise the functional modules or control objects. In a present implementation, the control objects are Microsoft Active X objects. Indeed, a library 22 of available control objects (e.g., Active X components) may reside on the HMI 12 to facilitate configuration of the HMI 12, as described below. While the HMI 12 may be configured directly on the HMI 12 itself, the resident library 22 enables configuration on a remote configuration station 24 by providing access to operational tools in accordance with the present techniques. Indeed, by storing the control objects in library 22 directly on the HMI, the risk of version conflicts and so forth are eliminated or reduced. Additionally, it should be noted that embodiments of the present techniques may incorporate an IP address (Internet Protocol address) with the graphical interface to facilitate access to the HMI 12 via network.

As discussed above, access to the library 22 may be provided to the configuration station 24 to facilitate development of applications (i.e., screen instructions and associated control objects) for the HMI 12 without necessitating the use of a conversion program. Accordingly, the library 22, along with any screen instructions already present on the HMI, may be uploaded to the configuration station 24 (e.g., laptop or workstation) through a communication link (e.g., Internet connection, network interface, or USB cable). In a presently contemplated embodiment, the configuration station automatically recognizes the HMI as a device when coupled to the configuration station (e.g., similar to an external memory or drive).

Once the screen instructions and/or control objects then resident on the HMI are loaded in the configuration station 24, aspects of the HMI 12 can be modified or updated and then downloaded back to the HMI 12. For example, a user may wish to update a particular HMI graphic to provide a historical data trending application relating to information being received from a newly installed sensor 18. Additionally, the user may find it desirable or convenient to update the HMI graphic with such an application while in an off-line mode (e.g., without the HMI 12 being present). In such a scenario, the user may upload the library 22 of available control objects to the configuration station 24 and use them to modify the HMI graphic or functionality by employing a configuration application (e.g., webpage creation software). As discussed below, such modifications may be made by composing new or modifying existing screen instructions, and by adding, removing, or modifying control objects called or executed in response to use inputs made by reference to the displayed HMI screens. Again, because the control objects available to configure the HMI 12 are accessed from the HMI 12 by the configuration station 24 during configuration, concerns relating to revision and capability differences between the configuration application and the HMI are minimal.

It should be noted that additional control objects can be added to the library 22. For example, if a trending control object is not resident on the HMI 12, a user can download such an object to the HMI 12 from a configuration library 26 resident on the configuration station 24. Alternatively, a user could upload the trending control object from a resource library 28 accessible via network (e.g., the Internet), and then download it to the HMI 12. This may be particularly beneficial because new and improved control objects can be downloaded to the HMI 12 individually and on a periodic basis, thus adding new functionality without necessitating the periodic release of new conversion programs.

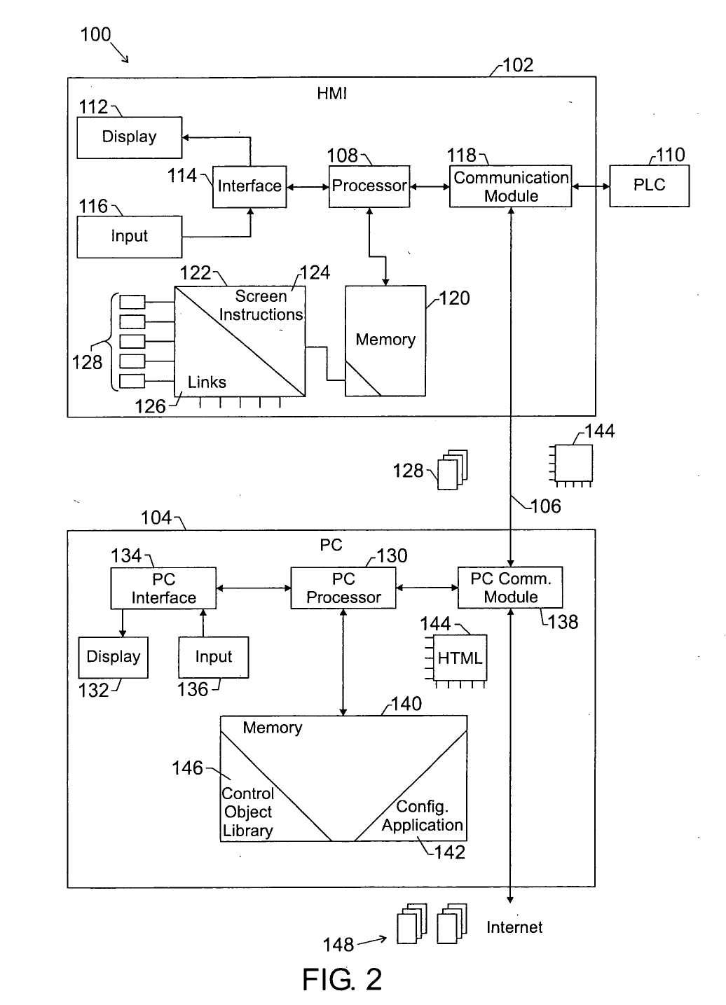

FIG. 2 is a block diagram illustrating interaction among components of both an HMI and a configuration station in accordance with embodiments of the present techniques. This interaction diagram may be referred to generally by reference numeral 100. Specifically, the interaction diagram 100 includes an HMI 102 that is in a communicative relationship with a general purpose computer (PC) 104 via data link 106. The data link 106 may comprise a direct cable link, a network link, or any interconnecting circuit between locations for the purpose of transmitting and receiving data. Further, both the HMI 102 and the PC 104 are illustrated as comprising certain exemplary components that facilitate operation and communication in accordance with embodiments of the present techniques.

The HMI 102 may comprise a configurable tool built around an HMI microprocessor 108. The HMI 102 may be adapted for interface with an industrial hardware interface such as a programmable logic controller (PLC) 110. While the HMI 102 may comprise many different parts and components, certain exemplary components are presently illustrated to demonstrate aspects in accordance with embodiments of the present techniques. Specifically, in addition to the processor 108, the illustrated embodiment includes a display module 112 (e.g., a graphical component or physical display screen), a display/input interface module 114, an input module 116 (e.g., keypad or touch-screen), a communication module 118 (e.g., TCP/IP component), and memory 120. In accordance with the present techniques, the memory module 120 may store computer programs and components such as a markup language page 122 (e.g., HTML page). The markup language page 122 may include any document created in a markup language that can be displayed. Multiple pages, such as page 122, may be stored in memory 120 for utilization in interfacing with a system or process. As discussed above, each such page will typically comprise screen instructions 124 and links 126 to pre-programmed functional modules or control objects. For example, the links 126 may cooperate with certain control objects 128 to facilitate display of system parameters and/or control of a related system or process. The HMI 12 may utilize such pages by employing a standard browser program.

The control objects 128 may comprise modular control strategies and graphical components that enable system configuration. For example, the control objects 128 may include modules for configuring one or more field devices (e.g., inputs and outputs) and related control logic (e.g., expressions). Indeed, these control objects 128 may be adapted to provide reusable configurations for process equipment, sensors, actuators, and control loops. As discussed above, in accordance with embodiments of the present techniques, available control objects may reside in a library stored on the memory module 120. Each control object 128 in accordance with present techniques may include a unique control tag, a data history, a display definition, and a control strategy. Further, each control object 128 may be a separate module, enabling operation, debugging, and transfer of individual objects 128 without affecting other objects. Indeed, to facilitate off-line configuration of the HMI 102, available control objects 128 may be uploaded through the communication module 118 and the data link 106 to a configuration station (e.g., PC 104). In many settings, and particularly in industrial automation contexts, “families” of such objects may be pre-defined, such as for various types of push buttons, trending modules, and so forth.

The PC 104, much like the HMI 102, may comprise a general purpose tool built around a PC microprocessor 130. The illustrated PC 104 is adapted for interface with the HMI 102 through data link 106 to facilitate configuration of the HMI 102. While the PC 104 may comprise many different parts and components, certain exemplary components are presently illustrated to demonstrate aspects in accordance with embodiments of the present techniques. Specifically, in addition to the processor 130, the illustrated embodiment includes a display module 132 (e.g., a graphical component or physical display screen), a display/input interface module 134, an input module 136 (e.g., keyboard), a communication module 138 (e.g., TCP/IP component), and a memory 140. In accordance with the present techniques, the memory module 140 may store computer programs and components such as a configuration application 142 adapted to configure a markup language page 144.

This configuration application 142 may be adapted to utilize a local control object library 146, control objects 128 uploaded from the HMI 102, or control objects 148 uploaded from an alternative remote location to configure the markup language page 144. For example, the configuration application 142 may allow a user to configure the page 144 in a development mode for use as a graphical interface in the HMI 102 utilizing control objects (e.g., 148) as functional elements. Once configured, the page 144 may be saved as a file, and downloaded to the HMI 102, where the page 144 may be utilized as an operable graphical interface.

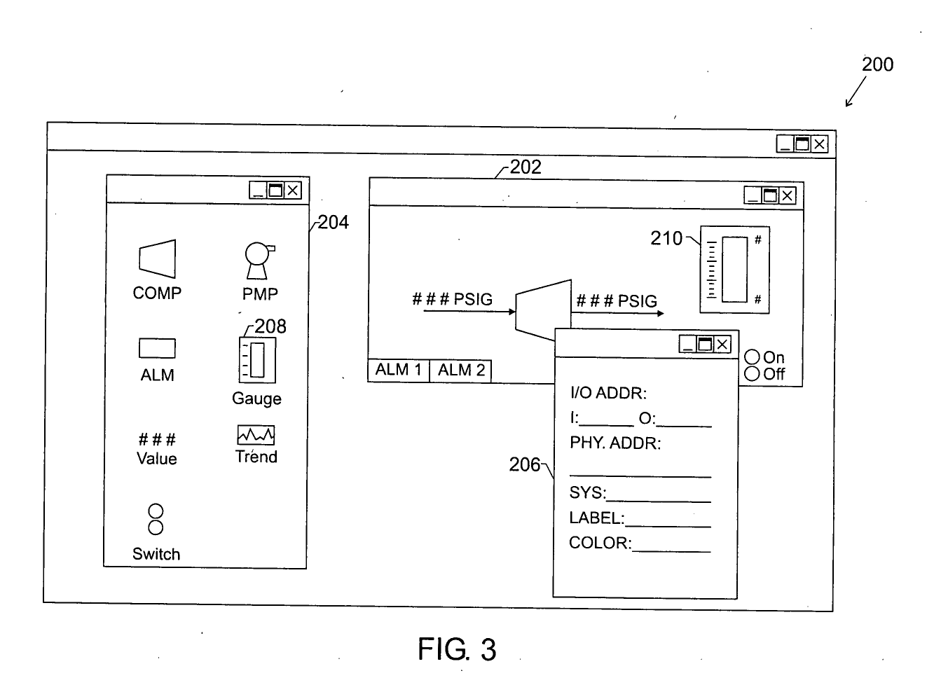

FIG. 3 is an exemplary representation of a configuration screen that is part of a configuration application package in accordance with embodiments of the present techniques. The configuration screen may be generally referred to by reference numeral 200. As illustrated, the configuration screen 200 comprises exemplary sub-screens that allow configuration of a markup language page for utilization as an HMI graphical interface screen. Specifically, the configuration screen 200 includes a development view sub-screen 202, a control object menu 204, and a properties sub-screen 206. While other screens and sub-screens may be employed, the present representation illustrates certain exemplary aspects in accordance with present techniques.

The development view sub-screen 202 may include an HTML document creation screen that utilizes screen instructions and links to provide an operable HTML page. The screen instructions may be programmed to facilitate navigation through various screens (e.g., HTML pages), programs, and functions corresponding to various different user inputs (e.g., input from a mouse). The links may reference and incorporate control objects adapted to facilitate interfacing of the HTML page with external input/output components. Indeed, a control object may be linked with an HTML page to facilitate an interface between an HMI and certain process components, where the HMI utilizes the HTML page as an operator interface screen. For example, in accordance with present techniques, by dragging-and-dropping a process object icon (e.g., “gauge” icon 208) from the control object menu 204 to the development screen 202, a control object may be incorporated graphically into development screen 202. Such a procedure may not only form a graphic 210 but it may also establish a specific control object for facilitating an interface between an HMI and a process.

Once a graphic, such as graphic 110, is properly located on the page being developed, the properties sub-screen 206 may become available for configuration in accordance with the present techniques. The illustrated properties sub-screen 206 relates to the graphic 110 and other corresponding aspects of the related control object. Such sub-screens may enable a user to define certain properties of related control objects. For example, the properties sub-screen 206 may enable a user to associate its related control object (including the corresponding graphic 110) with an input/output address (e.g., an I/O address on a PLC). Further, in accordance with present techniques, the properties sub-screen 206 may facilitate the incorporation of a tag or label (for identification of the control object), a physical address (for designating the location of related sensors and/or actuators), a dynamic visual component (e.g., logic to change graphic colors based on certain inputs), operational logic, and so forth. For example, a user may utilize the properties sub-screen 206 to link a control object including a representative graphic (e.g., a compressor graphic) to an I/O address in a PLC that is communicating with a status sensor. If the equipment is running, the graphic may be green. Alternatively, if the equipment is down, the graphic may be red. Additionally, logic in the related control object may send data to an I/O address on a PLC that is connected to an actuator, requesting that the actuator be energized based on the status of the equipment or other feedback.

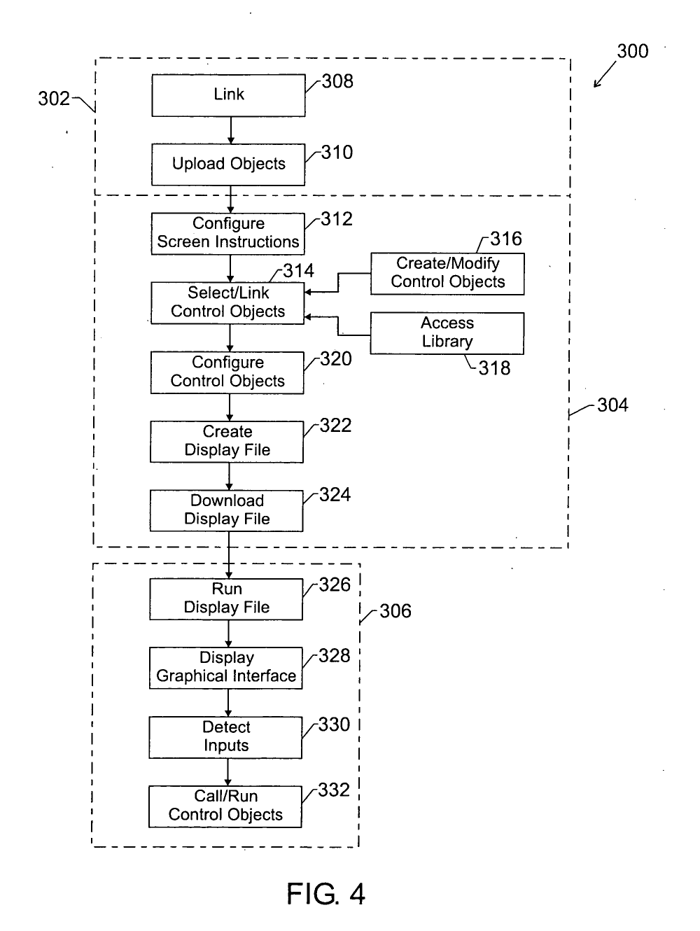

FIG. 4 is a block diagram illustrating a method for configuring and implementing an application (e.g., graphical interface) using a standard web interface in accordance with embodiments of the present techniques. The method may be generally referred to by reference numeral 300. Specifically, the method 300 may incorporate various procedures relating to different phases of operation. While FIG. 4 separately delineates specific procedures, in other embodiments, individual procedures may be split into multiple procedures or combined into a single procedure. In particular, the method 300 comprises a connection phase 302, a configuration phase 304, and an operation phase 306.

The connection phase 302, in accordance with the present techniques, includes linking an HMI to a configuration station (block 308) and uploading or simply accessing control objects (block 310) that are resident on the HMI to the configuration station. Once uploaded, the control objects may be utilized in the configuration phase 304 to develop an HTML page for use as a graphical interface. Linking the HMI and configuration station (block 308) may comprise the utilization of a network interface or direct connect cable, as discussed previously. Upon establishing such a link, the HMI may be recognized by the configuration station as an available device, such as a hard-drive. Thus, the control objects residing on the HMI may be accessed as programs in a file folder of the newly accessible hard-drive. Alternatively, a configuration program on the configuration station may directly access the control objects on the HMI using any number of applications (e.g., the control object menu 204 in FIG. 3).

Once the available control objects have been uploaded, assembly of a markup page may begin in the configuration phase 304 in accordance with the present techniques. The configuration phase may comprise configuring screen instructions (block 312) for the markup page and selecting/linking control objects (block 314). Specifically, block 312 may represent writing background instructions for coordinating aspects of a typical input device with the markup page and for other related functions. For example, the screen instructions may coordinate certain keyboard inputs with particular software functions (e.g., opening a software application when a particular button, or virtual button is pushed). The markup page may be further configured by selecting/linking control objects (block 314) to aspects of the page, thus incorporating the control objects as functional elements. This selecting/linking procedure (block 314) may include the creation/modification of control objects (block 316), and more particularly, of their properties, and the importation of control objects from a resource library (block 318). For example, as discussed previously, a new control object may be added to the HMI by retrieving it through the internet and downloading it to the HMI. Additionally, a configuration tool on the configuration station may allow a user to modify existing control objects and download the modified versions to the HMI.

In accordance with embodiments of the present techniques, the control objects being selected and linked in block 314 may require configuration. Such a procedure is illustrated by block 320, which may represent defining certain properties in control objects that enable the control objects to interface with external process components (e.g., I/O addresses on a PLC). It should be noted that this configuration procedure (block 320) may be integral to the development of the markup page or may occur in a separate procedural event. For example, each time a control block is linked to the page, it may require configuration. Alternatively, a control block may be linked and configured at any time. The result of the configuration phase in accordance with embodiments of the present technique may be the creation of a display file, as illustrated by block 322. This resulting display file may be downloaded to an HMI (block 324) for implementation as a graphical interface in accordance with embodiments of the present techniques.

The operation phase 306 may comprise the actual implementation of the markup page as a graphical interface on an HMI. Specifically, the procedures for such an implementation may include running the display file (block 326) created in block 322. This may result in the display of the graphical interface on a user-viewable screen of the HMI, as illustrated by block 328. Further, running the display file (block 326) may enable the detection of system and user inputs (block 330) in addition to activating the control objects (block 332). Indeed, an HMI may comprise embedded code that enables a standard internet browser to navigate and implement a number of such graphical displays and related control objects. Thus, embodiments of the present techniques may interact with a process to form a control and monitoring system using a standard web interface (e.g., HTML page).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A configurable human-machine interface comprising:
an input device;
a set of functional modules stored within the human-machine interface for generating configurable views to be displayed on a display, for interpreting inputs received via the input device, for processing parameter signals received from remote devices and for generating output signals, the set of functional protocols adapted for uploading to a remote configuration station; and
a set of screen instructions defined in a markup language for generating the configurable views and calling upon the functional modules based upon inputs received via the input device.

2. The interface of claim 1, comprising an Internet protocol interface for remotely addressing the human-machine interface to permit reconfiguration of the functional modules and the screen instructions via an Internet protocol.

3. The interface of claim 1, comprising a network interface configured to receive the parameter signals and send the output signals in an industrial data exchange protocol.

4. The interface of claim 1, comprising a viewable display.

5. The interface of claim 4, wherein the configuration tool permits adding of new functional modules to the human-machine interface.

6. The interface of claim 3, wherein the industrial data exchange protocol is an open industrial exchange protocol.

7. The interface of claim 1, wherein the configurable views include a static view and dynamic elements, the dynamic elements being altered in appearance based upon the parameter signals received by the human-machine interface.

8. The interface of claim 7, wherein the dynamic elements include parameter values of networked components.

9. The interface of claim 7, wherein the dynamic elements include an operative state of a networked component.

10. The interface of claim 1, wherein the markup language is HTML.

11. A configurable human-machine interface (HMI) system comprising:
an HMI including a set of functional modules stored within a human-machine interface for generating configurable views to be displayed on a display, for interpreting inputs received via an input device, for processing parameter signals received from remote devices and for generating output signals for reporting to or controlling remote devices, the set of functional modules adapted for uploading to a configuration station, and a set of screen instructions for generating the configurable views and calling upon the functional modules based upon inputs received via the input device;
a network interface configured to receive the parameter values and send the output signals in an industrial data exchange protocol; and
a configuration tool for accessing the functional modules and the screen instructions from the HMI, and for reconfiguring the screen instructions and the functional modules to create a reconfigured display file including the reconfigured screen instructions and functional modules, and for reloading the reconfigured display file to the HMI.

12. The configurable human-machine interface system of claim 11, wherein the screen instructions are defined in a markup language.

13. The configurable human-machine interface system of claim 11, wherein the configuration tool is adapted for accessing and reconfiguring the functional modules and the screen instructions via an Internet protocol interface.

14. A configurable human-machine interface system comprising:
a set of functional modules stored within the human-machine interface for generating configurable views to be displayed on a display, for interpreting inputs received via an input device, for processing parameter signals received from remote devices and for generating output signals for reporting to or controlling remote devices, the set of functional modules adapted for uploading to a configuration station;
a set of screen instructions for generating the configurable views and calling upon the functional modules based upon inputs received via the input device;
a network interface configured to receive the parameter values and send the output signals in an industrial data exchange protocol; and
a web-based reconfiguration tool for accessing the functional modules and the screen instructions directly from the human-machine interface and for reconfiguring the modules and screen instructions for storage on the human-interface module.

15. The configurable human-machine interface system of claim 14, wherein the screen instructions are defined in a markup language.

16. The configurable human-machine interface system of claim 14, wherein the configuration tool is stored in the configuration station.

17. A method for reconfiguring a human-machine interface, the method comprising:
accessing functional modules and a set of screen instructions in the human-machine interface via a web-based reconfiguration tool, the functional modules being configured for generating configurable views to be displayed on a display, for interpreting inputs received via an input device, for processing parameter signals received from remote devices and for generating output signals for reporting to or controlling remote devices, the screen instructions being configured for generating the configurable views and calling upon the functional modules based upon inputs received via the input device;
reconfiguring either the functional modules or the screen instructions via reconfiguration tool to create a reconfigured display file; and
storing the reconfigured display file on the human-machine interface.

18. The method of claim 17, comprising uploading the functional modules and the set of screen instructions from the human-machine interface to a configuration station.

19. The method of claim 17, wherein the screen instructions are in HTML.

20. The method of claim 17, comprising downloading the reconfigured functional modules or screen instructions from the configuration station to the human-machine interface.

21. A method for reconfiguring a human-machine interface comprising:
accessing a plurality of control objects from a human-machine interface via a configuration station;
configuring a display page on the configuration station, including links to the control objects to create a display file; and
downloading the display file to the human-machine interface for display of the display page and execution of the links to the control objects.

22. The method of claim 21, further comprising reconfiguring at least one of the control objects on the configuration station.

23. The method of claim 21, further comprising accessing an additional control object from a control object library, linking the additional control object to the display page, and downloading the additional control object to the human-machine interface.

24. The method of claim 21, wherein the display page is defined by computer code written in a markup language.

25. The method of claim 21, wherein the control objects include properties for accessing inputs via an industrial control and monitoring network, performing a function based on the inputs, and outputting a signal to a remote device via the industrial control and monitoring network.

26. A method for reconfiguring a human-machine interface comprising:
accessing a plurality of control objects from a human-machine interface via a configuration station, the control objects including properties for accessing inputs via an industrial control and monitoring network, performing a function based on the inputs, and outputting a signal to a remote device via the industrial control and monitoring network;
configuring a display page on the configuration station, including links to the control objects, to create a display file; and
downloading the display file to the human-machine interface for display of the display page and execution of the links to the control objects.
